(19) United States
(12) Patent Application Publication
(10) Pub. No.: US 2011/0046758 A1
(43) Pub. Date: Feb. 24, 2011

(54) AUDIO-CONTROLLING SYSTEM

(76) Inventors: Sampson Soo, Kowloon (CN); Wei-Ming Chiu, Chupei City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/545,330

(22) Filed: Aug. 21, 2009

(51) Int. Cl. G06F 17/00; H04B 1/00

(52) U.S. Cl. 700/94; 381/119

(57) ABSTRACT

An audio-controlling system has a mixer and an audio playing and controlling device. The mixer mixes an external audio signal and a controlling signal and then outputs a mixed audio signal to the audio playing and controlling device. The audio playing and controlling device is connected to the mixer to receive the mixed audio signal, plays the mixed audio signal and executes action according to controlling signal of the mixed audio signal. Therefore, The audio playing unit plays audio signal and the decoding unit outputs command codes to the actuator in wire or wireless way, so that the actuator automatically operates at the same time.

### BACKGROUND OF THE INVENTION

1. Field of the Invention

The present invention relates to an audio-controlling system, and more particularly to an audio-controlling system that generates an audio signal and a controlling command in synchronization so as to play the audio signal and start a function according to the controlling command.

2. Description of Related Art

Most of music players provide input device, such as bottoms, so that a user operates the input device of the music player to change different audio effect or adjust the volume to increase or decrease. In general, a user easily uses the input device of a portable music player, but always uses a remote control to control a high class of hi-fi equipment. For example, when the hi-fi equipment plays the music of an audio signal stored a CD or tape, the user often changes audio effects or adjusts the volume for the current music.

Further, lots of people have a music player at home or office and also have other electric devices, equipment or toy, of course, most of the electric devices provide the input device for users. Some of the electric devices, equipment or toy will be turned on when the music is playing. Therefore, the user has to turn on the music player, electric devices, equipment or toy one by one when the user would like to listen to the music. It is not convenient for user.

### SUMMARY OF THE INVENTION

The main objective of the present invention is to provide an audio-controlling system that generates an audio signal and a controlling command in synchronization so as to play the audio signal and start a function according to the controlling command.

The audio-controlling system has a mixer and an audio playing and controlling device. The mixer mixes an external audio signal and a controlling signal and then outputs a mixed audio signal to the audio playing and controlling device. The audio playing and controlling device is connected to the mixer to receive the mixed audio signal, plays the mixed audio signal and executes action according to controlling signal of the mixed audio signal. Therefore, The audio playing unit plays audio signal and the decoding unit outputs command codes to the actuator in wire or wireless way, so that the actuator automatically operates at the same time.

Other objectives, advantages and novel features of the invention will become more apparent from the following detailed description when taken in conjunction with the accompanying drawings.

### BRIEF DESCRIPTION OF THE DRAWINGS

FIG. 1 is a schematic drawing of generating a mixed audio signal of a mixer of an audio-controlling system in accordance with the present invention;

FIG. 2 is a functional block diagram of a decoding unit of the audio-controlling system in accordance with the present invention;

FIG. 3 is a functional block diagram of a first embodiment of an audio-controlling system in accordance with the present invention;

FIG. 4 is a functional block diagram of a second embodiment of an audio-controlling system in accordance with the present invention;

FIG. 5 is a functional block diagram of a third embodiment of an audio-controlling system in accordance with the present invention;

FIG. 6 is a functional block diagram of a fourth embodiment of an audio-controlling system in accordance with the present invention; and

FIG. 7 is a command list for FIG. 6.

### DETAILED DESCRIPTION OF THE FIRST EMBODIMENT

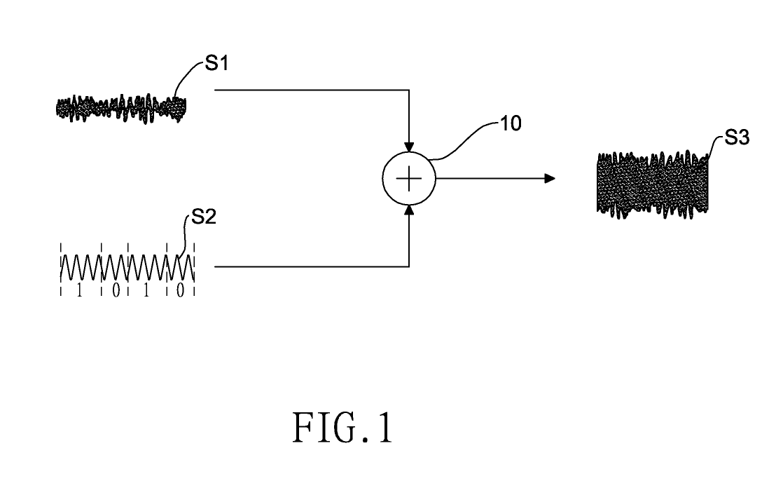

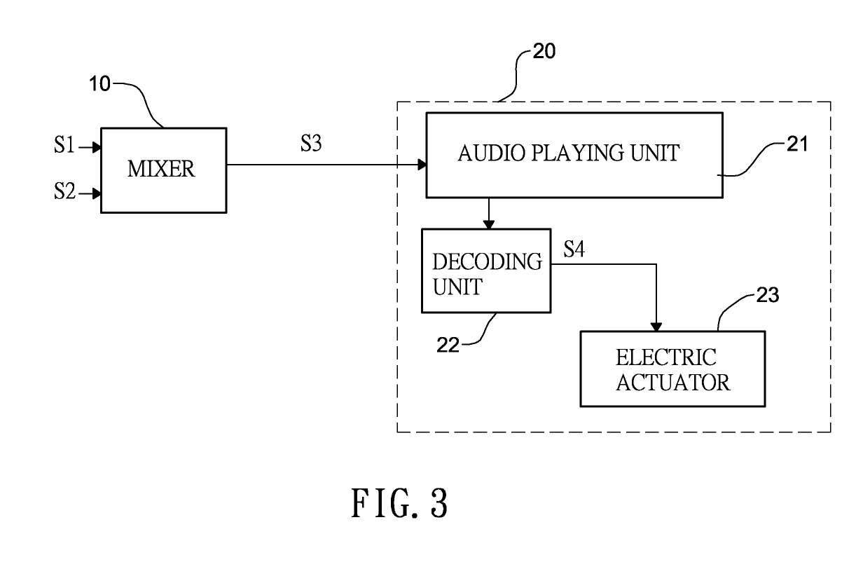

With reference to FIG. 3, an audio-controlling system has a mixer (10) and an audio playing and controlling device (20) connected to the mixer (10). With further reference to FIG. 1, the mixer (10) has two inputs and an output. The two inputs of the mixer (10) are respectively connected to an external audio signal (S1) and a controlling signal (S2). The mixer (10) mixes the audio signal (S1) and controlling signal (S2) and then outputs a mixed audio signal (S3) to the audio play and controlling device (10). Further, the controlling signal (S2) is consisted of a serial of sine wave signals (S21, S22) with different frequencies, each of which is between 15 KHz to 20 KHz and an amplitude of each sine wave signal (S21, S22) is limited lower than that of the external audio signal (S1). Therefore, the mixed audio signal (S3) is directly played when the controlling signal (S2) is embedded in the external audio signal (S1).

In the first embodiment, the controlling signal (S2) is consisted of multiple alternate low frequency sine wave signals (S21) and high frequency sine wave signals (S22). The amplitudes of the low and high frequency sine wave signals (S21, S22) are equal. For a binary command code, the low frequency sine wave signal (S21) may represent “1” bit and the high frequency since wave signal (S22) may represent “0” bit. The low and high frequency sine wave signals (S21, S22) are also respectively represent “0” bit and “1” bit of the binary command code. Therefore, to generate the controlling signal (S2) according to one binary command code “1010”, the controlling signal (S2) is consisted of alternate two low frequency sine wave signals (S21) and the two high frequency sine wave signals (S22).

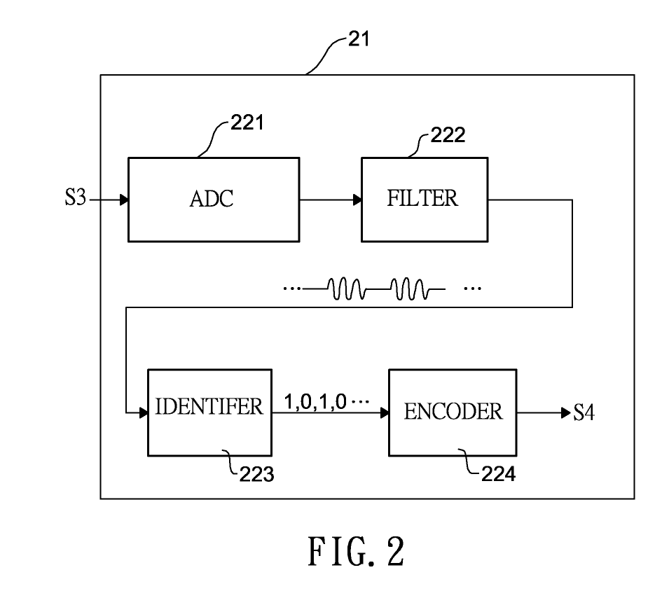

The audio playing and controlling device (20) has an audio playing unit (21), a decoding unit (22) and an electrical actuator (23). The audio playing unit (21) is connected to the output of the mixer (10) so as to receive the mixed audio signal (S3). Since the amplitude of the controlling signal (S2) is lower than the external audio signal (S1), human ear does not hear the controlling signal (S2). The audio playing unit (21) directly plays the mixed audio signal (S3). The decoding unit (22) is also connected to the output of the mixer (10) to receive the mixed audio signal (S3). With further reference to FIG. 2, the decoding unit (21) has an analog to digital converter (ADC) (221), a filter (222), a identifier (223) and an encoder (224). The ADC (221) is connected to the output of the mixer (10) and converts the mixer audio signal (S3) to a digital audio signal. Since the filter (222) and the identifier (223) are connected between the ADC (221) and the encoder (224), the digital audio signal is filtered and a corresponding binary command code is then extracted by the identifier (223). The binary command code is further encoded by the encoder (224) to another command code, such as octal or hexadecimal command code. The another command code is used as a driving command code (S4).

In the first embodiment, the filter (222) is a band pass filter. A center frequency of the band pass filter is equal to the frequency of the low frequency sine wave signal (S21), so the amplitudes of the high frequency sine wave signals (S22) is decreased. The amplitudes of the high frequency sine wave signals (S21) are lower than that of the low frequency sine wave signals (S22). Therefore, the filtered digital audio signal is decoded to the corresponding binary command code by the identifier (223). If the encoder (224) converters the binary command code to the octal command code, the encoder (224) is a binary to octal encoder. If the encoder (224) converters the binary command code to the hexadecimal command code, the encoder (224) is a binary to hexadecimal encoder. The decoding unit (21) may be implemented by a Digital Micro Control Unit (DMCU) that is a combination of a digital signal processor (DSP) and a micro control unit (MCU).

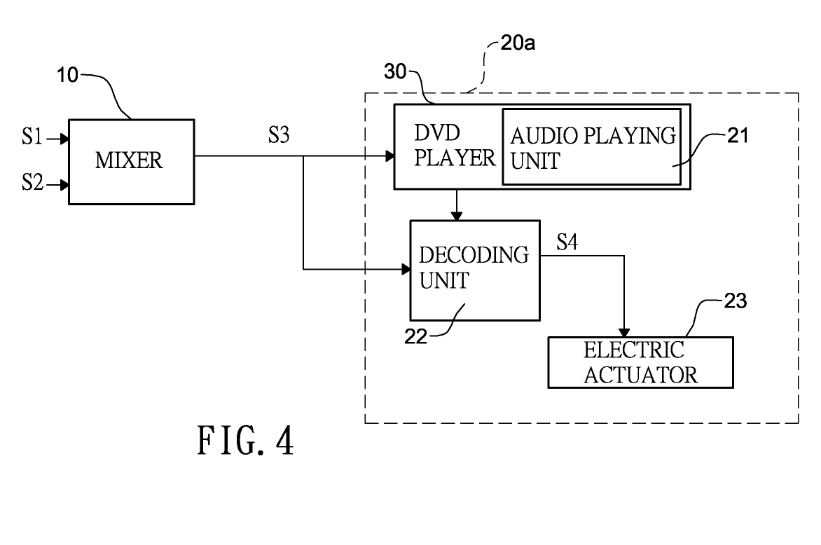

The electrical actuator (23) is connected to the decoding unit (224) and driven to execute different functions according to different command codes. The electrical actuator (23) may be wireless linked to the decoding unit (224). With further reference to FIG. 4, a second embodiment of an audio-controlling system in accordance with the present invention, the audio playing and controlling device is an audio and video playing system (20a) including a DVD player (30), a TV and a set of audio amplifiers (23). The audio playing (21) in accordance with the present invention is the DVD player (30) and the electrical actuator is the audio amplifier (23). The mixed audio signal (S3) from the mixer (10) is directly played by the DVD player (30). At the time, the mixed audio signal (S3) is received by the decoding unit (22) and the decoding unit (22) outputs the command code corresponding to the mixed audio signal (S3). When the audio amplifier (23) receives the driving command code (S4), the audio amplifier (23) executes the function according to the driving command code (S4), for example increasing volume, decreasing volume or changing sound effect . . . etc. Therefore, when the audio and video playing system (20a) auto-adjusts sound effects to match the present audio signal.

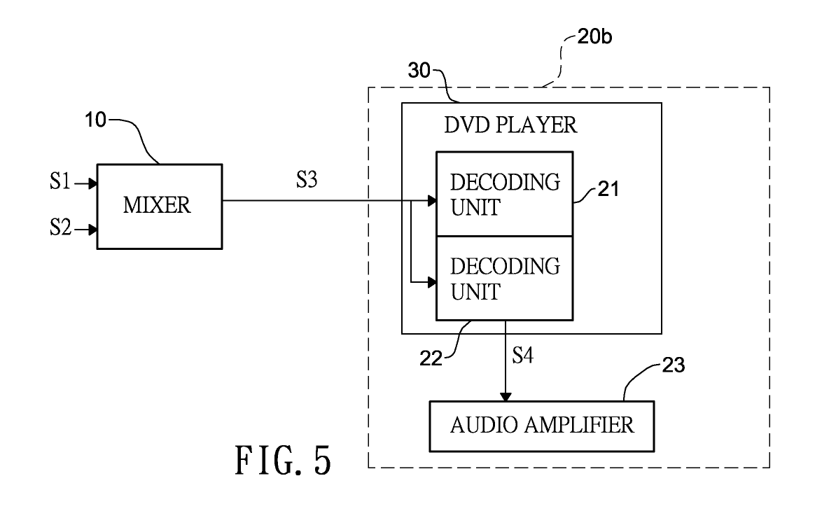

With reference to FIG. 5, a third embodiment of an audio-controlling system (20b) in accordance with the present invention is similar to the second embodiment, and the decoding unit (22) may be further integrated inside the DVD player (30).

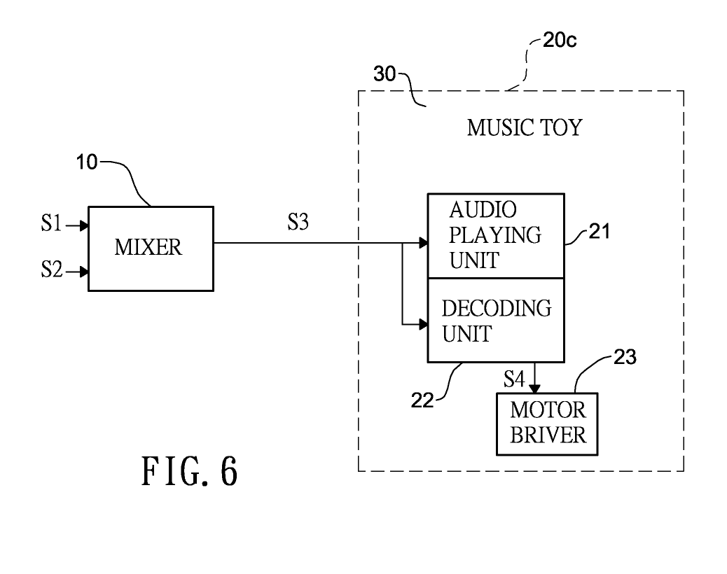

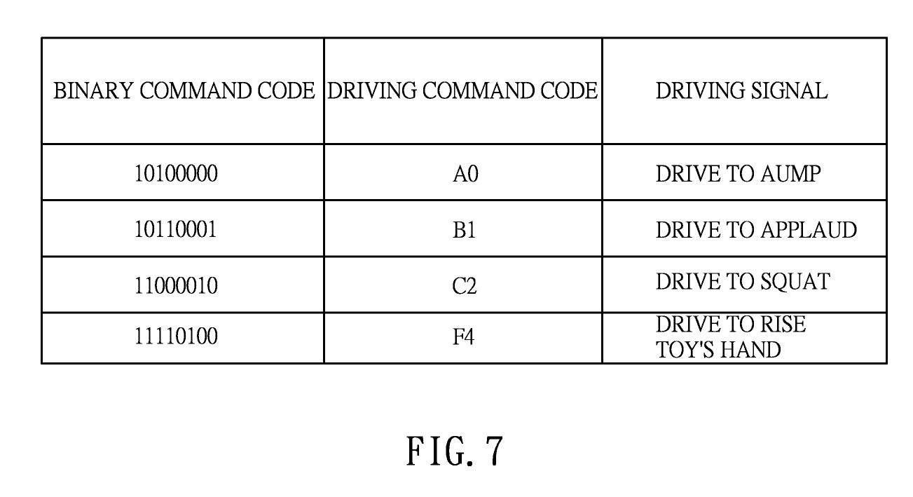

With reference to FIG. 6, a forth embodiment of an audio-controlling system in accordance with the present invention is further integrated inside a music electrical toy (20c) having an audio playing circuit (21) and a motor driver (23) and a motor (not shown) connected to the motor driver (23). Therefore, the audio playing unit of the present invention is the audio playing circuit (21) of the music toy (20c) and the electrical actuator of the present invention is the motor driver (23). The motor driver (23) further stores multiple driving signals according to hexadecimal command codes, as shown in FIG. 7. For example, the motor driver (23) outputs different driving signals to the motor to make the music toy (20) jump, applaud, squat and raise toy's hand.

Since the audio playing circuit (21) of the music toy (20c) plays the audio signals, the mixed audio signal (S3) from the mixer (10) is played by the audio playing circuit (21). The controlling signals (S2) are generated according to different binary command codes, each of which is corresponding to the hexadecimal command codes stored inside the motor driver (23). After the mixer (10) mixes the controlling signals (S2) and the external audio signal (S1) for the music toy (20c), the mixer (10) outputs the mixed audio signal (S4) including different controlling signals (S2) therein to the music toy (20c). The audio playing circuit (21) of the music toy (20c) plays the mixed audio signal (S3) directly. At the time, the motor driver (23) receives the hexadecimal command codes from decoding unit (22) and then determines the controlling signals (S2) in sequence according to the hexadecimal command codes. Therefore, the music toy (20) automatically does actions during playing the mixed audio signal (S3) of the music. The music toy manufacturer may generate different controlling signal to match different audio signal of music.

Based on the foregoing description, the audio-controlling system may be different applications. The audio playing unit plays audio signal and the decoding unit outputs command codes to the actuator in wire or wireless way, so that the actuator automatically operates at the same time.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An audio-playing system comprising:
a mixer having two inputs and an output, wherein the two inputs are respectively connected to an external audio signal and a controlling signal and then outputting a mixed audio signal to the output; and
an audio playing and controlling device connected to the output of the mixer to receive the mixed audio signal, playing the mixed audio signal and executing action according to controlling signal of the mixed audio signal, wherein the audio playing and controlling device comprises:
an audio playing unit connected to the output of the mixer to play the mixed audio signal after receiving the mixed audio signal;
a decoding unit connected to the output of the mixer to extract the controlling signal from the mixed audio signal; and
an actuator connected to the decoding unit to receive the controlling signal and execute action according to controlling signal.

2. The audio-controlling system as claimed in claim 1, wherein the controlling signal is consisted of a serial of sine wave signals with different frequencies, each of which is between 15 KHz to 20 KHz.

3. The audio-controlling system as claimed in claim 2, wherein the controlling signal is consisted of a serial of a low and high frequency sine wave signals, wherein the low and high frequency sine wave signals represents different bits for a binary command code.

4. The audio-controlling system as claimed in claim 3, wherein the low and high frequency sine wave signals respectively represents “1” bit and “0” bit in the binary command code.

5. The audio-controlling system as claimed in claim 3, wherein the low and high frequency sine wave signals respectively represents “0” bit and “1” bit in the binary command code.

6. The audio-controlling system as claimed in claim 4, wherein
the actuator further storing driving command codes according to different binary command codes; and
the decoding unit further comprises:
an ADC connected to the output of the mixer to convert the mixed audio signal to a digital audio signal;
a filter connected to the ADC to filter the digital audio signal to output a filtered digital audio signal;
a identifier connected to the filter to convert the filtered digital audio signal to a binary command code; and
an encoder connected to the identifier to encode the binary command code to the corresponding driving command code of the actuator.

7. The audio-controlling system as claimed in claim 5, wherein
the actuator further storing driving command codes according to different binary command codes; and
the decoding unit further comprises:
an ADC connected to the output of the mixer to convert the mixed audio signal to a digital audio signal;
a filter connected to the ADC to filter the digital audio signal to output a filtered digital audio signal;
a identifier connected to the filter to convert the filtered digital audio signal to a binary command code; and
an encoder connected to the identifier to encode the binary command code to the corresponding driving command code of the actuator.

8. The audio-controlling system as claimed in claim 6, wherein the filter is a band pass filter having a center frequency that is equal a frequency of the low frequency sine wave signal of the controlling signal, so as to decrease an amplitude of the high frequency sine wave signal.

9. The audio-controlling system as claimed in claim 7, wherein the filter is a band pass filter having a center frequency that is equal a frequency of the high frequency sine wave signal of the controlling signal, so as to decrease an amplitude of the low frequency sine wave signal.

10. The audio-controlling system as claimed in claim 8, wherein the encoder is a binary to a hexadecimal encoder.

11. The audio-controlling system as claimed in claim 8, wherein the encoder is a binary to an octal encoder.

12. The audio-controlling system as claimed in claim 8, wherein the decoding unit is connected to the actuator in wire or wireless way.

13. The audio-controlling system as claimed in claim 1, wherein the audio playing unit is an audio player.

14. The audio-controlling system as claimed in claim 13, wherein the decoding unit is integrated inside the audio player.

15. The audio-controlling system as claimed in claim 14, wherein the audio player is a DVD player.

16. The audio-controlling system as claimed in claim 1, wherein the audio playing and controlling device is integrated with a music toy.

17. The audio-controlling system as claimed in claim 8, wherein the audio playing unit is an audio player.

18. The audio-controlling system as claimed in claim 13, wherein the decoding unit is integrated inside the audio player.

19. The audio-controlling system as claimed in claim 18, wherein the audio player is a DVD player.

20. The audio-controlling system as claimed in claim 8, wherein the audio playing and controlling device is integrated with a music toy.
